(19) United States
(12) Patent Application Publication
(10) Pub. No.: US 2008/0162356 A1
(43) Pub. Date: Jul. 3, 2008

(54) PORTABLE ELECTRONIC DISPLAY DEVICE FOR VIEWING PUBLICATIONS AND METHOD OF USING THE SAME

(76) Inventors: Jeff Parket, Great Neck, NY (US); Adam Wachter, New York, NY (US)

Correspondence Address: DARBY & DARBY P.C., P.O. BOX 770, Church Street Station, New York, NY, 10008-0770, US

(21) Appl. No.: 11/616,531

(22) Filed: Dec. 27, 2006

(51) Int. Cl. G06Q 99/00

(52) U.S. Cl. 705/53

(57) ABSTRACT

A method and system for viewing and distributing publications such as newspapers, magazines, catalogs, books, and the like in electronic format is provided. A portable device downloads electronic publications from a distributor and allows a user to view downloaded electronic publications. The portable device tracks the usage of the downloaded electronic publications and sends the usage information to the distributor. The distributor compiles the usage information it receives from one or more portable devices and provides the compiled usage information to the publishers of the electronic publications. The distributor receives compensation for distribution and/or production of compiled usage information.

### FIELD OF THE INVENTION

The present invention relates generally to portable electronic display devices. More specifically, the present invention relates to the viewing of electronic publications on a portable electronic display device and to the distribution of electronic publications, such as a newspaper or a magazine, in electronic format, to the portable electronic display device.

### BACKGROUND OF THE INVENTION

Conventionally, publications such as newspapers, magazines, catalogs, books, and the like are printed on paper and distributed physically by mail or other means. In recent years, publications have become available in electronic format to allow readers to read publications using a computer. Publications in electronic format have become increasingly accessible on the World Wide Web and additionally, portable devices for viewing electronic publications have become available.

Electronic publication has the potential to provide enormous savings to conventional publishers. A conventional publisher must incur large costs for raw materials and services for printing a publication on paper. Furthermore, a conventional publisher must incur costs for storing and physically distributing its printed publications to readers. Unlike the conventional methodology, a publisher making its publications available in electronic format can eliminate or substantially reduce such costs since no raw material, printing, or physical hand delivery or storage is required. Hence, conventional publishers can benefit enormously from popularization of portable devices for viewing electronic publications.

Portable devices for viewing electronic publications, however, have not made a major impact in replacing the conventional system of publishing and distributing printed publications. Portable devices tend to be costly and often require the consumer to make additional payments to receive electronic publications, often at a price comparable to purchasing conventional printed publications. Hence, prior approaches of making electronic publications available on portable devices have not been very compelling to consumers and portable devices for viewing electronic publications have not become very popular.

Accordingly, what is needed is a new approach for viewing and providing electronic publications on portable devices that is compelling to consumers while still providing the potential of great cost savings to publishers.

### SUMMARY OF THE INVENTION

The present invention is directed to a method and system for viewing and distributing publications, such as newspapers, magazines, catalogs, books, and the like, in electronic format. In one aspect, the present invention provides a portable device for viewing electronic publications in a manner that is similar to the manner in which conventional printed publications are viewed. The present invention further provides a distribution system for transmitting electronic publications to portable devices.

In the distribution system, a distributor receives electronic publications from a publisher and distributes the electronic publications to portable devices via a communications network. Once an electronic publication is received by a portable device, the electronic publication can be viewed on the portable device by a user. As the user views the electronic publication on the portable device, usage of the electronic publication is tracked by the portable device. The usage information is transmitted via the communications network from the portable device to the distributor. The distributor compiles the usage information it receives from the portable devices and provides the publisher with the usage information relevant to its electronic publications. Based on the usage information, the publisher provides financial compensation to the distributor for the distribution and usage of its electronic publications.

In a further embodiment of the present invention, electronic publications are distributed for free to users of portable devices. Hence, consumers are provided with a compelling financial motivation to substitute conventional printed publications with electronic publications. In yet another embodiment of the present invention, a publisher is charged for distribution of an electronic publication based on the number of users that have viewed its electronic publication, and also based on the time viewers have spent viewing the publication. For publishers of newspapers and magazines who typically incur a loss in producing and distributing conventional publications and earn a profit by selling advertisement space to advertisers, the present invention provides such publishers with a financially advantageous opportunity to provide its publications electronically at a much more efficient cost. Such a publisher can reduce its expenses by publishing electronically rather than through conventional means and can make its publications more attractive to advertisers by increasing its readership by making its publications more widely available.

In an alternative embodiment, users of portable devices and/or publishers can be charged a fee for receiving electronic publications.

### BRIEF DESCRIPTION OF THE DRAWINGS

The foregoing and other features of the present invention will be more readily apparent from the following detailed description and drawings of the illustrative embodiments of the invention wherein like reference numbers refer to similar elements throughout the drawings, in which:

FIG. 1A is an illustration of an embodiment of a portable device for viewing electronic publications;

FIG. 1B is an illustration of another embodiment of a portable device for viewing electronic publications;

FIG. 2 is an illustration of an adapter for providing power and wireless communication to a portable device;

FIG. 3 is a block diagram of a system for distributing electronic publications from a publisher to portable devices;

FIG. 4 is a flow chart of an interaction between a portable device and a distribution system;

FIG. 5 is a flow chart of a process for monetizing the distribution of electronic publications; and

FIG. 6 is an illustration of an example computer system in which a portable device, a distributor, and other aspects of the present invention may be implemented in accordance with the present invention.

### DETAILED DESCRIPTION OF A PREFERRED EMBODIMENT

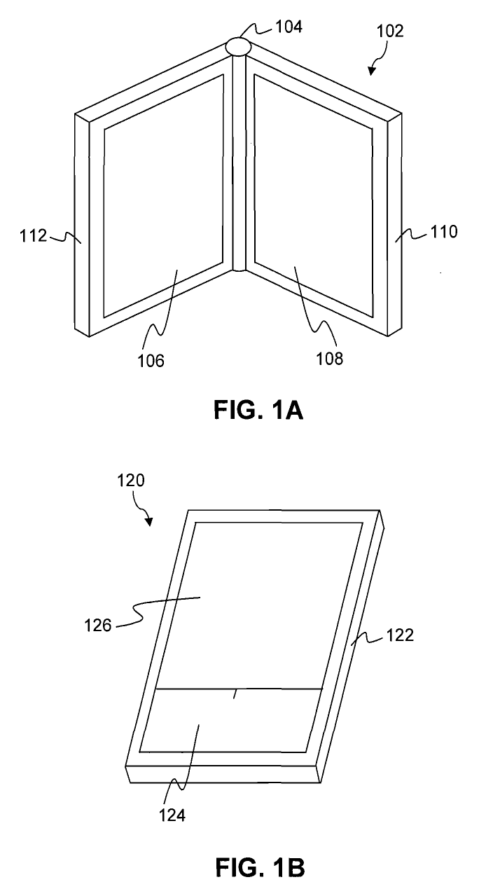

Preferred embodiments of the present invention are now described with reference to the drawings. Referring to FIG. 1A, an embodiment of a portable device 102 for viewing electronic publications in accordance with the present invention is illustrated. Portable device 102 includes two panels 110 and 112 joined by hinge 104. Each panel 110 and 112 includes a display 106 and 108, respectively. Portable device 102 further includes a processor, a memory, a battery, a storage device, and an input for receiving power and/or receiving and transmitting data, which are fairly conventional and not shown in FIG. 1A. The exterior of the user device can be made of graphite or other materials that may be lighter, thinner and/or more durable. Additionally, the battery can be removed and replaced with a fresh battery. In one example, each battery can provide power to portable device 102 for continuous operation over a period of at least one and a half hours. As will be appreciated by those skilled in the art, other components that are typically included in a laptop computer can also be incorporated into portable device 102.

Hinge 104 allows panels 110 and 112 to be rotated nearly 360 degrees relative to each other. This allows displays 106 and 108 to be protected when panels 110 and 112 are closed such that panels 110 and 112 are in contact with each other. Furthermore, hinge 104 allows panels 110 and 112 to be opened in a manner that is similar to the way a traditional book or newspaper is opened for reading. Additionally, hinge 104 allows panels 110 and 112 to be opened such that displays 106 and 108 are facing opposite directions. Displays 106 and 108 can also be touch-screen displays. By utilizing touch-screen displays, a user can provide input to portable device 102 by touching displays 106 and 108.

Also, portable device 102 may alternatively be configured with a single panel 122 as shown in FIG. 1B as portable device 120, in which case hinge 104 would not be needed. For example, portable device 120 can be configured in a tablet like format with a single color display 124 having a dimension of 11 inches by 14 inches, 11 inches by 12.5 inches, or any suitable size, and with retractable cover 126 attached to the device that can be used to protect the display when the device is not in use.

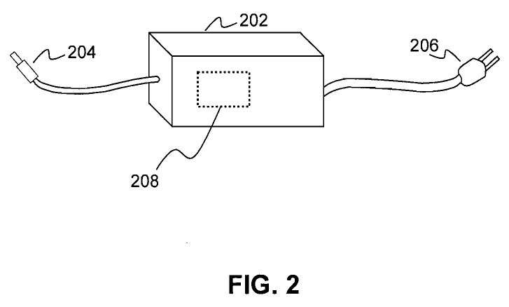

Referring to FIG. 2, an embodiment of an adaptor 202 for providing power and wireless communication to portable device 102 in accordance with the present invention is illustrated. Adaptor 202 includes a power plug 206 for receiving power from a wall outlet and a connector 204 for connecting to portable device 102. Adaptor 202 further includes a wireless transceiver 208, such as for example, an 802.11 transceiver, a Bluetooth transceiver, or the like. Connector 204, when attached to portable device 102, provides portable device 102 with power and access to wireless communication. As will be appreciated by those skilled in the art, other types of wired or wireless transceivers may be included in adapter 202. Providing the wireless transceiver 208 as part of adaptor 202 eliminates the need for having the transceiver be part of portable device 102, and therefore allows portable device 102 to be smaller and lighter.

In an alternative embodiment, portable device 102 includes the wireless transceiver and there is therefore no need to include the transceiver in adapter 202. In such an alternative embodiment, adapter 202 supplies only power to portable device 102. As will be appreciated by those skilled in the art, other types of wired and wireless transceivers can be included in portable device 102.

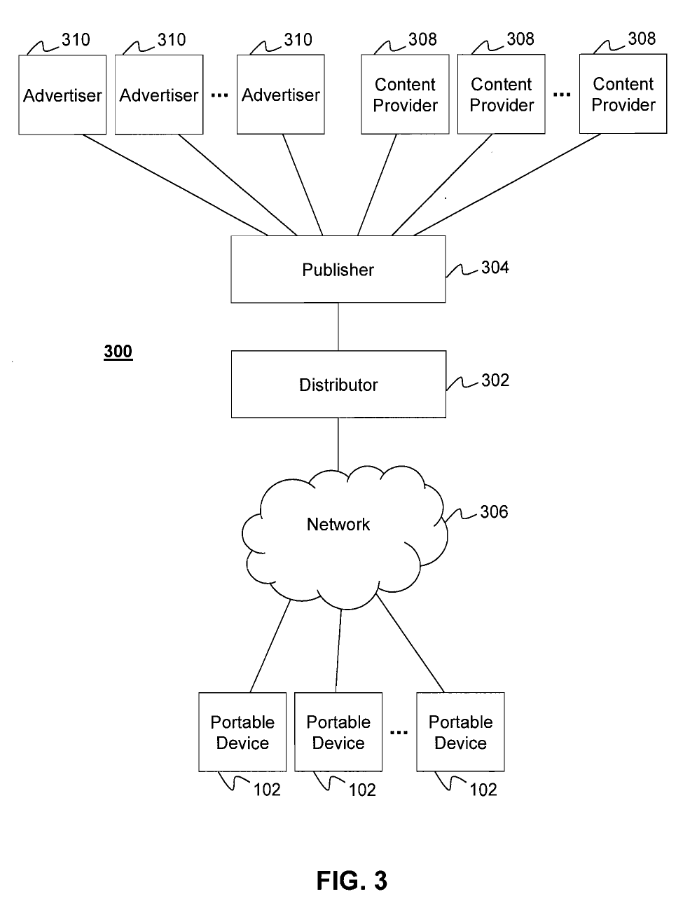

Referring to FIG. 3, therein is illustrated a block diagram of system 300 for distributing electronic publications from a publisher to one or more portable devices 102 in accordance with the present invention. Distributor 302 is capable of communicating with one or more portable devices 102 via network 306. Network 306 can be, for example, the Internet, a proprietary network, a satellite based network, and the like. Each portable device 102 can communicate with network 306 via a transceiver in adapter 202 or alternatively via a transceiver within portable device 102.

Publisher 304 is in communication with one or more advertisers 310 and one or more content providers 308. Each content provider 308 is a source of content that may be used in a publication such as, for example, an author, a photographer, the Associated Press, Reuters, a blogger, and the like. Publisher 304 can be, for example, a publisher of newspapers, magazines, catalogs, books, and the like. Publisher 304 communicates with one or more advertisers 310 and/or one or more content providers 308 to receive advertisements and content, respectively, to create a publication in electronic format. Publisher 304 communicates with distributor 302 to provide the electronic publications for distribution by distributor 302. Publisher 304 communicates with advertisers 310, content providers 308, and distributor 302, for example, by using a communications network as is well known.

Distributor 302 makes electronic publications received from publisher 304 available for downloading by one or more portable devices 102 via network 306. A registration process may also be included in order for the distributor to obtain information regarding the individual users, such as demographics, preferences, settings, etc. Demographic information for an individual user includes age, sex, occupation, education, family size, geographic location, time zone, income level, etc. This registration process is also used to later identify and keep track of the activities of individual users, as discussed in more detail below. Once an electronic publication is downloaded by portable device 102, the electronic publication can be viewed by the user of the portable device. Portable device 102 tracks the usage of each downloaded electronic publication by a user and transmits the usage information to distributor 302. Usage information collected from one or more portable devices 102 is compiled by distributor 302 and the compiled usage information is provided to publisher 304.

As will be appreciated by those skilled in the art, the foregoing and other functionality of distributor 302 can be implemented as a computer executing software. Additionally, distributor 302 can access a database to store electronic publications, usage information, and other data in accordance with the present invention. Alternatively, the functionality of distributor 302 can be implemented on multiple computers and/or databases in a distributed fashion.

Although a single publisher 304 is shown, distributor 302 can communicate with multiple publishers to distribute numerous electronic publications to each portable device 102. When distributor 302 operates with multiple publishers, distributor 302 provides each publisher with compiled usage information that includes usage information which is related to that particular publisher's electronic publications.

In one embodiment, distributor 302 provides portable device 102 with a list of electronic publications that are available for download. Portable device 102 presents the list to its user in a graphical user interface (GUI) in the form of, for example, an electronic newsstand, bookstore, or the like. Using the GUI, the user can select one or more electronic publications to be downloaded from distributor 302 to the user's portable device 102. Alternatively, a user can subscribe to a serial electronic publication. When portable device 102 and distributor 302 are in communication, a check is performed by either portable device 102 or distributor 302 to determine if new issues of any subscribed serial electronic publications are available and the new issues are automatically downloaded to portable device 102. Furthermore, the user can specify desired times at which new issues are automatically downloaded to portable device 102.

When an electronic publication is downloaded to portable device 102, a user can view the electronic publication utilizing a GUI on portable device 102. The user interface provided by portable device 102 allows the user to view a particular page or select a link within a page to quickly view a different page. For example, by touching a thumbnail of each page or by touching elements of a scroll bar on the touch-screen display, the user can move directly to a particular page and return to a prior page. Additionally, the interface of portable device 102 allows the user to change the display size of the electronic publication so that the user can view the electronic publication zoomed in and out. Furthermore, the interface of portable device 102 allows the user to view the electronic publication in portrait orientation or landscape orientation so that the user can view the length of the display horizontally or vertically. In another example, the interface of portable device 102 allows the user to touch an article or an advertisement on the touch-screen display to have the entire article or advertisement appear in the display if it is possible to do so without zooming the article or the advertisement. These features can be activated by touching appropriate points on the touch-screen display.

In another embodiment, a user can utilize an interface on portable device 102 to interact with a third party other than distributor 302. For example, a user can select a portion or all of an electronic publication and email it to a destination or email a reference to the content (e.g., a URL). When emailing from the user device, the user can input a new email address, for example, by touching the keys of a keyboard displayed on the touch-screen display or by selecting a predefined email address by touching the email address from a list of email addresses on the touch-screen display. In another example, a user can select an advertisement and request more information from the advertiser by touching an appropriate icon. Furthermore, a user can select items in a catalog and place an order with the publisher or content provider.

When a user utilizes portable device 102 to interact with a third party, portable device 102 can communicate directly with the third party through a communications network or indirectly with the third party by first transmitting information to distributor 302. Once the transmitted information is received by distributor 302, the information is relayed to the third party by distributor 302. If a transceiver is not installed on portable device 102, attempts to email third parties are stored in the portable device 102. When the user connects with adaptor 202, the user can press a synch button on portable device 102 to have portable device 102 access transceiver 208 in adapter 202 to transmit the emails that were stored in the portable device 102.

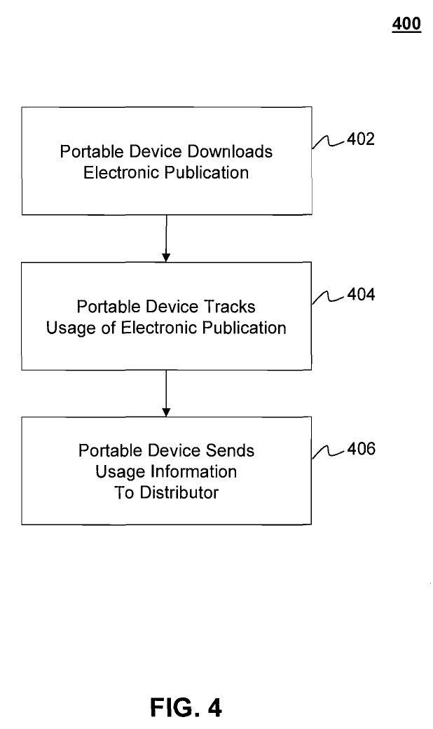

Referring to FIG. 4, therein is illustrated a flow chart for a process 400 that can be implemented on portable device 102 for interacting with distributor 302. In step 402, portable device 102 downloads an electronic publication via network 306 from distributor 302. Electronic publications are downloaded to portable device 102 when a user manually selects a publication for download or are downloaded automatically based on the user's subscriptions. In one embodiment, electronic publications are downloaded for free. Alternatively, electronic publications are downloaded for a fee.

Once an electronic publication is downloaded, it is stored on portable device 102 and made accessible for viewing by the user. The user can remove the electronic publication from portable device 102 by selecting the electronic publication for deletion through the user interface on portable device 102. Alternatively, old or expired electronic publications can be deleted automatically by portable device 102 to make space for new electronic publications.

In step 404, portable device 102 tracks the usage of electronic publications by the user of the device. Portable device 102 tracks, for example, which electronic publication was viewed, when the electronic publication was viewed, and the duration of the viewing. Furthermore, portable device 102 can track a user's interaction with third parties. For example, portable device 102 can track advertisers and/or advertisements for which the user made a request for more information. Additionally, portable device 102 can track the destinations and the portions of an electronic publication that were transmitted by the user to a third party.

In step 406, portable device 102 transmits usage information to distributor 302 via network 306. Portable device 102 can upload usage information whenever it connects to network 306 after it has been disconnected. Additionally, portable device 102 can send the usage information to distributor 302 periodically when it communicates with distributor 302. Alternatively, portable device 102 can send the usage information when requesting new electronic publications from distributor 302.

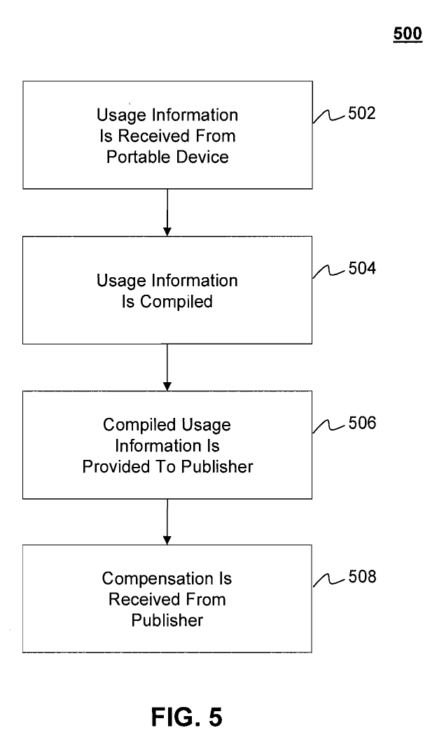

Referring to FIG. 5, therein is illustrated a flow chart of a process 500 for monetizing or facilitating payments for distribution of an electronic publication. Process 500 can be implemented in software when distributor 302 is embodied as a computer system.

In step 502, usage information tracked by a portable device 102 is received by distributor 302. Additionally, distributor 302 can receive usage information from multiple portable devices 102, each separately tracking usage information for its corresponding user.

In step 504, usage information received in step 502 is compiled by the distributor. Usage information can be compiled to aggregate, for example, the number of times an electronic publication was viewed, the number of users that viewed an electronic publication for a particular time period, or the number of times each article was emailed. Additionally, usage information can be compiled to generate the average amount of time a user viewed a publication. Usage information can also be compiled to generate a report providing the number of users that requested more information from a particular advertiser. Furthermore, usage information can be compiled to provide the number of times an order was placed for a product appearing in a catalog listing or an advertisement of an electronic publication. Such usage information can be compiled for all the users who viewed an electronic publication or for groups of users that are within a particular demographic. For example, usage information can be compiled to provide the number of male users, number of female users, number of users between the ages of 20 and 40, the number of users in a household of 3 or more persons, and the like who viewed an electronic publication for a particular time period.

In step 506, compiled usage information that is related to electronic publications of a particular publisher is provided to that publisher. The compiled usage information allows a publisher to get an account of the readership of its electronic publications. By using the compiled usage information, a publisher can charge its advertisers a fee based on readership. Additionally, a publisher can charge its advertisers an additional fee for each user that requested more information from a particular advertiser.

In step 508, compensation is received from the publisher for the distribution by distributor 302 of the publisher's electronic publication(s). Compensation can be based on the compiled usage information such as, for example, the aggregate number of users that viewed the electronic publication for a particular time period. Additionally, compensation is received from a publisher for the generation of the compiled usage information itself. Compensation can be received electronically by an electronic funds transfer or other electronic banking mechanisms.

Additionally, compensation can be received by an entity affiliated with distributor 302. An entity affiliated with distributor 302 can include a natural person, a business, a reseller of services offered by distributor 302, and the like. Compensation can be provided by the publisher to such an entity by utilizing one or more financial transaction mechanisms offered by banks and other similar institutions such as, wire transfers, checks, cashier's check, automatic deposits, etc.

In another embodiment, distributor 302 can receive and compile usage information for electronic publications it did not itself distribute to portable devices 102. In such an embodiment, portable device 102 can download electronic publications directly from other portable devices, online libraries, the World Wide Web, databases or other repositories accessible to network 306. Thereafter, distributor 302 can obtain compensation from publisher 304 for providing usage information for electronic publications it did not itself distribute.

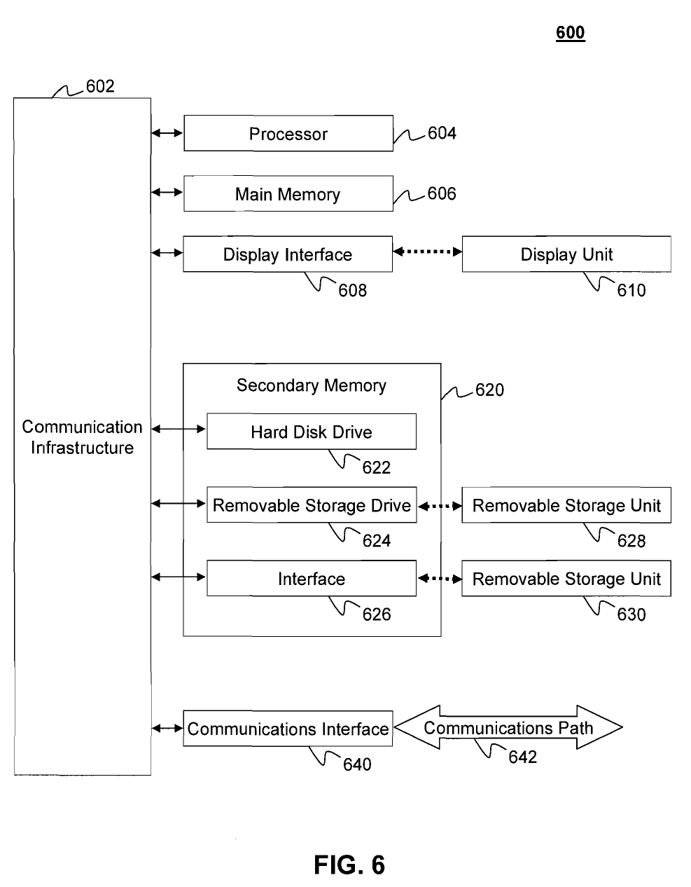

The following description of a general purpose computer system is provided for the sake of completeness. Portable device 102, distributor 302, and other aspects of the present invention can be implemented in hardware, or as a combination of software and hardware. Consequently, the invention can be implemented in the environment of a computer system or other processing system. An example of such a computer system 600 is shown in FIG. 6. In the present invention, all of the processing blocks or steps of FIGS. 4 and 5, for example, can execute on one or more distinct computer systems 600, to implement the various methods of the present invention. Computer system 600 includes one or more processors, such as processor 604. Processor 604 can be a special purpose or a general purpose digital signal processor. Processor 604 is connected to communication infrastructure 602 (for example, a bus or network).

Computer system 600 can include display interface 608 that forwards graphics, text, and other data from communication infrastructure 602 (or from a frame buffer not shown) for display on display unit 610. Display unit 610 can be, for example, a liquid crystal display (LCD), a plasma display panel (PDP), touch-screen display, and the like.

Computer system 600 also includes main memory 606, preferably random access memory (RAM), and can also include secondary memory 620. Secondary memory 620 can include, for example, hard disk drive 622 and/or removable storage drive 624, representing a floppy disk drive, a magnetic tape drive, an optical disk drive, a flash memory card reader or the like. Removable storage unit 628 represents a floppy disk, magnetic tape, optical disk, flash memory card, or the like, which is read by and written to by removable storage drive 624. As will be appreciated, removable storage unit 628 includes a computer usable storage medium having stored therein data and/or computer software.

In alternative implementations, secondary memory 620 can include other similar means for allowing computer programs or other instructions to be loaded into computer system 600. Such means can include, for example, removable storage unit 630 and interface 626. Examples of such means can include a program cartridge and cartridge interface (such as that found in video game devices), a removable memory chip (such as an EPROM, or PROM) and associated socket, and other removable storage units 630 and interfaces 626 which allow software and data to be transferred from removable storage unit 630 to computer system 600.

Computer system 600 can also include communications interface 640. Communications interface 640 allows software and data to be transferred between computer system 600 and external devices. Examples of communications interface 640 can include a modem, a network interface (such as an Ethernet card), a wireless transceiver, a communications port, a PCMCIA slot and card, etc. Software and data transferred via communications interface 640 are in the form of signals which can be electronic, electromagnetic, optical or other signals capable of being received by communications interface 640. These signals can be provided to communications interface 640 via communications path 642. Communications path 642 carries signals and can be implemented using wire or cable, fiber optics, a phone line, a cellular phone link, an RF link and other communications channels.

As used herein, the terms “computer program medium” and “computer usable medium” are used to refer generally to media such as removable storage units 628 and 630, a hard disk installed in hard disk drive 622, and the like. These computer program products are means for providing software to computer system 600.

Computer programs (also called computer control logic) are stored in main memory 606 and/or secondary memory 620. Computer programs can also be received via communications interface 640. Such computer programs, when executed, enable computer system 600 to implement user device 102, distributor 302, and other aspects of the present invention as discussed herein. In particular, the computer programs, when executed, enable processor 600 to implement the processes of the present invention, such as the methods described with reference to FIGS. 4 and 5, for example. Accordingly, such computer programs represent controllers of computer system 600. Where the invention is implemented using software, the software can be stored in a computer program product and loaded into computer system 600 using removable storage drive 624, interface 626, or communications interface 640.

In another embodiment, features of the invention are implemented primarily in hardware using, for example, hardware components such as Application Specific Integrated Circuits (ASICs) and gate arrays. Implementation of a hardware state machine so as to perform the functions described herein will also be apparent to persons skilled in the relevant art(s).

Although preferred embodiments of the invention have been disclosed for illustrative purposes, those skilled in the art will appreciate that many additions, modifications and substitutions are possible, without departing from the scope and spirit of the invention.

1. A method for distributing electronic publications comprising the following steps:
receiving by a distributor at least one electronic publication from a publisher;
transmitting said electronic publication by the distributor to at least one user over a communications network;
tracking usage of said electronic publication by said user to generate usage information;
compiling the usage information by the distributor; and
transmitting the compiled usage information from the distributor to the publisher;
and providing compensation from the publisher to the distributor based on the compiled usage information.

2. The method of claim 1, further comprising the step of registering said user to obtain information regarding the user.

3. The method of claim 2, further comprising the step of transmitting by the distributor to the user a list of available publications.

4. A method for viewing electronic publications by a user using a portable electronic display device, the method comprising the following steps:
receiving at least one electronic publication from a distributor over a communications network;
viewing said electronic publication using said portable electronic display device, wherein said display device includes at least one touch-screen display, wherein said viewing step further comprises the step of:
touching a first image on the display in order to view a selected portion of the publication.

5. The method of claim 4, further comprising the step of touching a second image on the screen to electronically transmit the selected portion of the publication to a recipient.

6. The method of claim 4, further comprising the step of touching a third image on the screen to electronically receive selected advertising information;

7. The method of claim 4, further comprising the step of touching a fourth image on the screen to purchase a selected product.

8. A portable electronic device for use by a user in viewing publications electronically transmitted to the portable device, the portable device comprising:
a touch-screen display;
a programmed processor operative to perform the following steps:
receive at least one electronic publication from a distributor over a communications network;
provide the electronic publication for display on the touch-screen display;
process user input in the form of touches to the touch-screen display;
provide a selected portion of the publication for display on the touch-screen in response to a user input touch of a first image on the display; and
cause the electronic transmission of the selected portion of the publication to a recipient in response to a user input touch of a second image on the display.

9. The portable electronic device of claim 8, wherein the programmed processor is further operative to cause the electronic reception of selected advertising information in response to a user input touch of a third image on the display.

10. The portable electronic device of claim 8, wherein the programmed processor is further operative to cause the purchase of a selected product in response to a user input touch of a fourth image on the display.

11. The portable electronic device of claim 8, further comprising a power adapter for providing power to the portable device, the power adapter further comprising a wireless transceiver operative to provide wireless communication for the portable device while the portable device is connected to the power adapter and the adapter is connected to a source of power.

12. The portable electronic device of claim 11, wherein the wireless transceiver is operative to automatically initiate communication over the communications network when the portable device is connected to the power adapter.

13. The portable electronic device of claim 11, wherein the wireless transceiver is operative to automatically receive at least one electronic publication when the portable device is connected to the power adapter.

14. The portable electronic device of claim 8, further comprising a second touch-screen display hingedly connected to said touch-screen display.
